(19) United States
(12) Patent Application Publication
(10) Pub. No.: US 2010/0246566 A1
(43) Pub. Date: Sep. 30, 2010

(54) Serverless gateway infrastructure for voice or video

(75) Inventor: Wei Kang Tsai, Irvine, CA (US)

Correspondence Address: Wei Kang Tsai, 8 Young Court, Irvine, CA, 92617, US

(73) Assignee: Grasstell Networks LLC

(21) Appl. No.: 12/383,725

(22) Filed: Mar. 26, 2009

(51) Int. Cl. H04L 12/66

(52) U.S. Cl. 370/352

(57) ABSTRACT

A system and method to provide voice or video over IP without a centralized control infrastructure is enabled by an overlay network of software devices. Such a device is comprised of VoIP server, PBX, PBX database, and a control module. The control module is used to store and retrieve items stored in the distributed databases hosted on the overlay networks. Two main functions provide by the serverless infrastructure are: VoIP call setup and tear-down, and accounting for a service provider.

### CROSS REFERENCE TO RELATED APPLICATION

This application claims the benefit of U.S. Provisional Patent Application Serial No. 61/070,116, filed Mar. 20, 2008, the disclosure of which is herein expressly incorporated by reference.

### FIELD OF THE INVENTION

The present invention relates in general, to the voice infrastructure for telecommunication, and more particularly, to a distributed serverless architecture for control signaling needed in delivering voice or video over IP services.

### BACKGROUND OF THE INVENTION

VoIP (voice or video over IP) services are mainly offered by two groups of providers: classic PSTN (Public Switched Telephone Network) companies, and cable companies that offer voice services. The first group will be referred to as telcos, and the second group as the cablecos; both groups will be collectively referred to as carriers.

For the purpose of the present invention, video-over-IP is meant to be video calls over IP. Therefore, there are no fundamental differences between voice calls and video calls except in the video case, video streams are also used in the communications.

To deliver VoIP services, two types of equipment must work together: gears and communication channels within service provider networks and customer premise equipment (CPE) at customer sites. Groups of collaborating CPE at customer sites will be referred to as CPE networks. A combined infrastructure of service provider networks and CPE networks will be called an extended network. In the standard networking jargon, a CPE network is considered as an edge network. Thus, an extended network is comprised of a core and an edge, wherein the core network now refers to the entirety of the service provider network, which itself may be comprised of a separate core and edge.

From control viewpoint, all operations in an extended network can be classified into data plane and control plane operations. Data plane refers to the dimension wherein voice data are being manipulated and delivered; while control plane refers to the dimension wherein control signaling is being implemented.

A fundamental problem in controlling voice traffic is that distributed nodes in an extended network are unable to possess timely global information to set up voice paths properly without conflicts and impairments. Therefore, control and signaling has always been done in a centralized way. Centralization has its costs: a network is not scalable in that performance does not scale up ideally as load increases and as the infrastructure is upgraded. Therefore, a common compromise is to implement a centralized distributed system: a hierarchical structure.

Being a middle-of-the-road solution, hierarchical control is not perfectly scalable. Therefore, completely distributed solutions have always been sought by both researchers and practitioners.

While ideal distributed infrastructure does not exist, recent breakthroughs in academia have enabled practical distributed infrastructures. These breakthrough technologies are commonly known to as overlay-SIP (or P2P-SIP, or simply overlay). A working group within the IETF is currently drafting P2P-SIP standards based on these developments. Here SIP stands for session initiation protocol and P2P stands for peer-to-peer.

With the overlay SIP technology, it is now possible to achieve practically distributed directory search and other control signaling without a centralized infrastructure of servers.

The present invention aims to capitalize on the recent developments in the overlay technology. An objective of the present invention is to create an extended network whereby a significant part of both control signaling and traffic delivery is shifted to the CPE network.

Such an approach represents a significant departure from the modus operandi of the carriers. In fact, depending on specific embodiments, the majority of control and signaling work load in the extended network may actually be carried by CPE networks, instead of provider core networks.

Another differentiation of the present invention is that the present invention allows distributed implementation of an extended network in a plurality of ways. In one embodiment, the entire server infrastructure for the control plane in a core network is completely replaced by devices in a CPE network. In another embodiment, while the servers in the control plane remain in a core network, they are not centrally controlled.

Accounting is an important control function in a carrier's network. Another differentiation of the present invention is that the accounting function can be carried out by a distributed serverless extended network. Accordingly, the majority of accounting functions can actually be implemented in a CPE network. In yet another embodiment, accounting servers residing inside a core network are not centrally controlled.

In the present invention, a CPE is usually often a gateway sitting between the public Internet and a private IP network. In a home setting, such a gateway is referred to as a home gateway (HG); in an office setting, such a gateway is referred to as an office gateway (OG).

### BRIEF SUMMARY OF THE INVENTION

It is therefore an object of the present invention to provide an architecture and method whereby the CPE network carries the majority of the work load for control signaling for VoIP services.

It is another object of the present invention to provide an architecture and method that allows for the removal of communication center (CC) (100 in FIG. 1) infrastructure while maintaining the communication semantics of the telephony system. In the telco jargon, a CC is often known as a CO (central office). Servers (120) are used to set up and tear down VoIP calls, which are conducted through VoIP terminals (110).

It is another object of the present invention to leverage on the communication-friendly properties of cable and DSL modems, or HG and OG, or in general, CPE, to construct a VoIP system without CC.

In accordance with one aspect of the present invention, there is provided a high-level design to delineate the functional modules inside a logical device called a grassnode (GN) that performs control signaling for voice or video services over IP.

The present invention provides a high-level design to delineate functional modules within a GN that perform for both PBX (private branch exchange) and accounting functions for video/voice over IP services. In addition, if a GN is also connected to a PSTN line, the present invention provides logic to switch between different VoIP call options and PSTN call options.

### BRIEF DESCRIPTION OF THE DRAWINGS

The above and other objects and features in accordance with the present invention will become apparent from the following descriptions of embodiments in conjunction with the accompanying drawings, and in which:

FIG. 1 depicts a conventional VoIP communications system;

FIG. 2 shows the architecture view at level-1;

FIG. 3 shows the architecture view at level-2;

FIG. 4 shows a typical PBX database;

FIG. 5 shows the architecture view at level-3;

FIG. 6 shows the architecture view at level-3 with accounting services;

FIG. 7 demonstrates the accounting tuples.

### DETAILED DESCRIPTION OF EXEMPLARY EMBODIMENTS

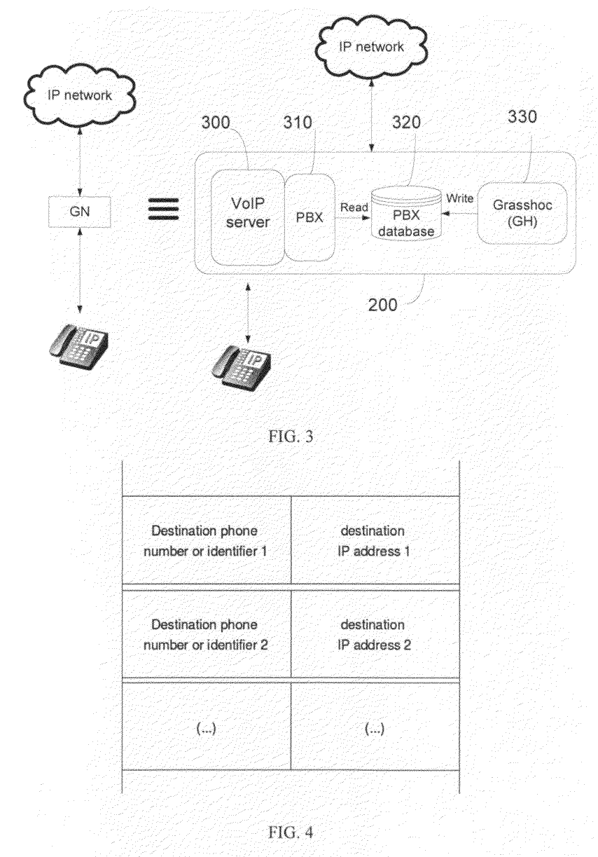

A main device in the serverless distributed architecture of the present invention is called a grassnode, GN (200 in FIG. 2 and FIG. 3). A GN is a logical device; in most embodiments it is implemented as a software module sitting inside a CPE device or a server. FIG. 2 presents a view of the architecture at the broadest level (level-1). In FIG. 2, all control plane operations are accomplished through GNs (200) in a P2P (peer to peer) manner.

A GN node embeds the methods in the present invention that enable maintenance of the semantics of a VoIP communications system, even without a CC infrastructure.

In the present invention, an HG or OG is a hardware device to embody a GN device. A GN device could also be embodied in a server or an unspecified hardware device inside a service provider network. Further, the entirety of an extended network will be referred to as a VoIP system.

More than likely, an HG or OG may possess specific communication-friendly properties, which are useful in the present invention, such as:
(1) HG's and OG's being assigned public IP addresses;
(2) Absence of NAT boxes between an HG or OG and the public Internet;
(3) Absence of firewalls between an HG or OG and the public Internet;
(4) Presence of UPS module (uninterruptible power supply) integrated with an HG or OG.

The above properties will allow an HG or OG to be strategically located in a CPE network, according to the present invention. These properties enable the GN embodied inside an HG or OG device to perform control functions in a preferred manner. For instance, the absence of NAT and firewall boxes between a GN device and the public Internet enables the distributed protocols implemented by GN to perform optimally. Similarly, the presence of a UPS module in an HG and OG device ensures that a GN module is operational even in the event of electric blackout.

FIG. 3 presents a view of the architecture at level-2. According to an embodiment, a GN (200) is an IP device embodied inside a gateway, sitting between a private IP network and another IP network. The GN is comprised of four components: VoIP server (300), PBX (310), PBX database (320) and a grasshoc (GH, 330) module. The VoIP server 300 is a module performing VoIP control operations such as setting up and tearing down calls between terminals.

The PBX module 310 is a module responsible for resolving the call destination numbers using a PBX database 320. A typical PBX database implementation consists of a table with two columns, one being the destination number to call and the other being the IP address associated with the destination number to forward voice packets. An example of PBX data base is shown in FIG. 4. According to this embodiment, a row in the PBX table will be referred as a PBX tuple.

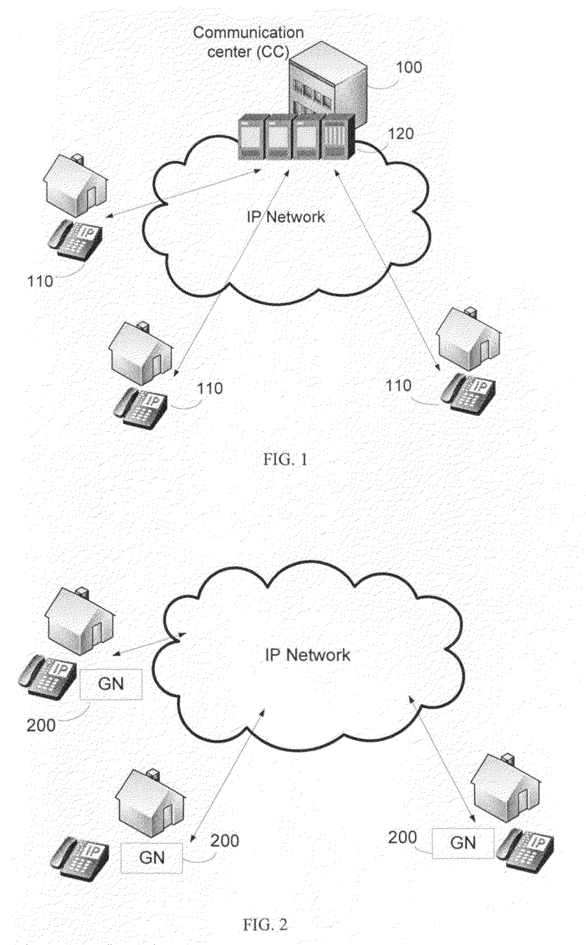

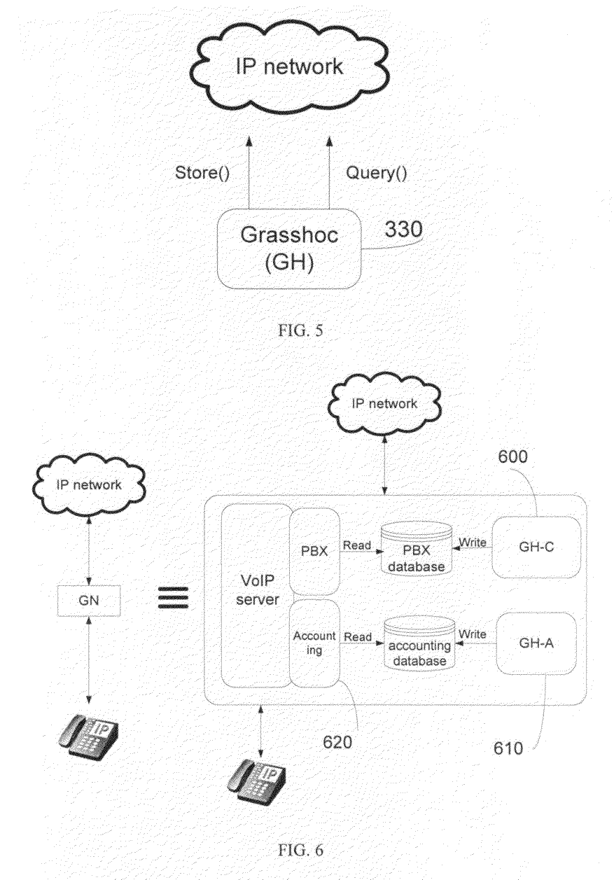

It should be noted that in the traditional architecture shown in FIG. 1, VoIP server, PBX and PBX database components are all implemented in a CC infrastructure. Instead, according to most embodiments of the present invention, these three elements are replicated and integrated within a GH module (330 in FIG. 3 and FIG. 5) in GN devices, while no CC infrastructure is present.

According to an embodiment, a grasshoc (GH) module is added to perform overlay-related functionalities. In its most simplified form, a GH module is a software module performing a set of distributed protocols with two simple interfaces: store( ) and query( ). This is illustrated in FIG. 5. The store( ) interface is responsible for storing a PBX tuple in some arbitrary GN (chosen by the distributed protocol implemented in the GH modules) in the system. The query( ) interface is responsible for retrieving a PBX tuple from the GN at which it is stored.

According to an embodiment, GNs implement the following booting algorithm. Let PBXT be the PBX tuple of an arbitrary GN. PBXT is of the form PBXT=[PN, IPA], wherein PN and IPA are the phone number and the IP address assigned to GN, respectively. When a GN is turned on, its GH module immediately issues a store( ) call to the VoIP system, passing the GN's PBX tuple PBXT as a parameter. The store( ) call will store the PBX tuple in an arbitrary GN node in the VoIP system (chosen by the distributed protocol implemented in the GH) in a way that any future query( ) issued by any GN in the VoIP system to resolve the phone number PN will return the PBX tuple PBXT.

According to an embodiment, PBX databases and GH modules act as a 2-layer caching scheme. When a call is to be established, the responsible VoIP server will first use the local PBX database to resolve the destination. If the target destination is present in the local PBX database, the call is established without any further work. If the PBX tuple needed to resolve the call is not present in the PBX database, the local GH module is then invoked. The GH module resolves the PBX tuple by issuing a query command to the VoIP system. Once the GH module resolves the PBX tuple, it stores it in the local PBX database. Finally, the local VoIP server sets up the call using the newly cached PBX tuple.

According to other embodiments, a GN device is also equipped to perform accounting functionalities. FIG. 6 shows the GN architecture with the added accounting function. Two GH modules are embedded into the node. These two GH modules are named GH-C 600 and GH-A 610, respectively. GH-C 600 is designed to enable calls between nodes (this is the same GH module described earlier); while GH-A 610 is designed for performing store and query operations related to accounting, and an additional accounting module 620 is attached to the VoIP server.

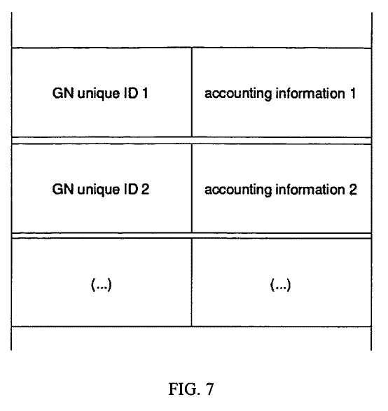

GH-A 610 performs store( ) and query( ) operations on accounting tuples, whereas GH-C 600 performs storage( ) and query( ) operations on PBX tuples as previously described. FIG. 7 shows the structure of accounting tuples as they are stored in an accounting database. Each tuple is made of two components: an ID that uniquely identifying the GN that this tuple is representing, and the accounting information corresponding to the GN.

According to these embodiments, when a new accounting activity is generated by a VoIP server—for instance, the recording of the duration of a phone call performed by a GN—the VoIP server issues a store( ) command using the local GH-A module. This command will then store the accounting information into an arbitrary node in the underlying VoIP system. The arbitrary node can be an ordinary GN or a special-purpose node performing only accounting services. This second option may be preferable in the case when security is a concern. For instance, a network operator providing services using the present invention may prefer to have accounting servers secured and separate from GN networks. With this solution, accounting tuples can then be retrieved by any network node that has a GH-A module.

According to yet another embodiment, when a GN device embedded in a gateway that is also equipped with regular PSTN functionalities, then the rules of switching between VoIP and PSTN services include but are not restricted to:
(1) If a call is an emergency-911 call, and a PSTN line is alive, then a PSTN emergency-911 line will be used.
(2) If the regular power supply is out, then a regular PSTN line will be used.
(3) Upon setting up a call, if the query( ) issued by a GH-C fails to find the IP tuple corresponding to the destination number, then a regular PSTN line will be used. Here the PSTN line can be understood as a third level of caching. First the GN tries to use the local PBX database; if resolution fails, then the GN tries to use the GH module; if that also fails, then the GN falls back to using a regular PSTN line. This method also enables a smooth and natural migration from a PSTN infrastructure to a pure VoIP infrastructure.

According to another embodiment, the entirety or a part of the GN devices in an extended network are embodied in servers or other hardware devices distributed inside a service provider network.

What is claimed is:

1. A method to enable distributed control infrastructure for voice or video over IP services, comprising:
a plurality of software devices called grassnodes, forming a P2P overlay;
and an IP-based communication network;
wherein each said grassnode is connected to other grassnodes through said IP network; each said grassnode is further comprised of a VoIP server module, a PBX module, a PBX database, and a grasshoc module; a distributed search algorithm is implemented among said grassnodes through which a grassnode is able to locate the IP address of a grassnode containing needed control information, for the purpose of providing said services.

2. The method of claim 1, wherein a said grassnode is embedded in a hardware device which can be either a CPE device or a core network device; in particular, such a device can be a home gateway, an office gateway, an IP router, a wireless router, a server, or any computing, or communication device that is connected to an IP network.

3. The method of claim 2, wherein said grasshoc is a software module implementing a set of distributed protocol with two commands: store( ) and query( ) wherein
(1) said store( ) command causes a data item to be stored in a distributed database hosted on said P2P overlay;
(2) said query( ) command causes a data item to be retrieved from a distributed database hosted on said P2P overlay;

4. The method of claim 3, wherein distributed databases hosted in said overlay network may include the followings:
(1) PBX databases for VoIP or video over IP applications;
(2) accounting databases for VoIP or video over IP applications.

5. The method of claim 4, wherein the set of grassnodes that implement accounting functionalities are secure may be completely hosted inside a provider network.

6. The method of claim 3, wherein said overlay network of grassnode implements a booting algorithm as follows:
(1) each said grassnode is assigned a phone number as its ID and an IP address;
(2) upon booting, a grassnode is registered into a PBX database with the phone number its ID, and the assigned IP address as its address in the PBX database.

7. The method of claim 6, wherein if a grassnode is also connected to PSTN line, the following logic is implemented in setting up a call through a grassnode:
(1) if a call is an emergency-911 call, and a PSTN line is alive, then a PSTN emergency-911 line will be used;
(2) if the regular power supply is out, then a regular PSTN line will be used;
(3) if the local PBX fails to produce a valid IP address for the callee, then the grassnode will go to the distributed PBX database; if this again fails, then a live PSTN line will be provided to the calling terminal.

8. A computer-readable medium with a computer program for performing the method as described in any one of claims 1 to 7.
